(19) United States
(12) Patent Application Publication
(10) Pub. No.: US 2020/0306758 A1
(43) Pub. Date: Oct. 1, 2020

(54) SYSTEMS, METHODS AND DEVICES FOR MAGNETIC SCANNING FOR FERROFLUID BASED ASSAY

(71) Applicants: Thabani Abigail DHLAKAMA, New Haven, CT (US); Ancera LLC, Branford, CT (US)

(72) Inventor: Thabani Abigail DHLAKAMA, New Haven, CT (US)

(73) Assignee: Ancera LLC, Branford, CT (US)

(21) Appl. No.: 16/772,681

(22) PCT Filed: Dec. 12, 2017
(86) PCT No.: PCT/US2017/065883

§ 371 Date: Jun. 12, 2020

(51) Int. Cl. B01L 3/00; G01N 15/10; B03C 1/28; B03C 1/32

(52) U.S. Cl. CPC B01L 3/502761; G01N 15/1056; B01L 3/502715; G01N 2015/0053; B03C 1/288; B03C 1/32; B01L 3/50273

(57) ABSTRACT

Embodiments herein include a scanning apparatus for detecting target particles present within a ferrofluid, where the scanning apparatus can be used in a microfluidic system. The methods and structures described herein also include, for example, a scanning device comprising an optical system, a first magnet disposed on a first side of the optical system, where the first magnet can be non-rotatable, a second magnet disposed on a second side of the optical system, opposite the first magnet, where the second magnet can be rotatable, and a lever arm coupled to the second magnet, where the lever is capable of rotating the second magnet.

### FIELD

The disclosure generally relates to a scanning device for ferrofluid based assays and methods of using the same.

### BACKGROUND

Conventional laboratory testing and measurement systems may be comprised of at least two components: an instrument and a cartridge. The instrument provides power and excitation signals to perform a given assay and measures generated signals to ultimately quantify the result of the said assay. The cartridge can be inserted into the instrument and provides an interface between the instrument and the assay. The cartridge may comprise receptor regions with which to capture targeted moieties, by surface functionalization, for example.

In some assays, reagents flow within channels inside the cartridge, and across receptor regions. The reagents transport the targeted biological and/or chemical moieties relevant to the assay from input reservoirs into different compartments within the cartridge, such as the receptor regions. Biocompatible ferrofluids may be used for the controlled manipulation and rapid separation of both microparticles and live cells, where differences in particle size, shape, and elasticity may be utilized to achieve rapid and efficient separation. A scanning apparatus may be used to determine the identity and concentration of the targeted moieties.

### SUMMARY OF SOME OF THE EMBODIMENTS

In some embodiments of the present disclosure, a magnetic force directing method for directing at least one non-bound particle in a microfluidic channel towards a surface of the microfluidic channel is provided. The method includes moving a scanning device across a capture region of a microfluidic channel. The scanning device includes an optical system, a first magnet disposed on a first side of the optical system, where the first magnet may be non-rotatable. The device also includes a second magnet disposed on a second side of the optical system, opposite the first magnet, where the second magnet may be rotatable. The device further comprises a lever arm coupled to the second magnet. The lever arm can be configured to rotate the second magnet. The method further includes rotating a pole of the second magnet to face a like pole of the first magnet, and producing a magnetic force to push at least one non-bound particle in the microfluidic channel towards a first surface of the microfluidic channel.

Such embodiments, as well as others, may include one or more (i.e., one and/or combinations) the following features, structures, steps, functionality, and/or clarifications, each addition and combinations of additions yielding yet further embodiments of the disclosure:
moving the first magnet and the second magnet away from the microfluidic channel along the sides of the optical system;
the first and second magnet are moved away from the microfluidic channel a predetermined distance;
the predetermined distance can be between about 12 mm to about 16 mm away from the microfluidic channel;
the magnetic force does not push the at least one non-bound particle towards the first surface of the microfluidic channel;
a plurality of target particles are bound to a functionalized surface of the capture region, and/or a plurality of non-bound particles are disposed adjacent the bound target particles;
the scanning device detects the plurality of bound particles in the capture region, but does not detect the non-bound particles in the microfluidic channel;
counting the bound particles in the capture region;
the plurality of target particles remain bound to the functionalized surface; and
rotating a pole of the rotatable magnet comprises moving the lever a distance towards the surface of the channel.

In some embodiments, a scanning device is provided and includes an optical system, a first magnet disposed on a first side of the optical system, where the first magnet may be non-rotatable, a second magnet disposed on a second side of the optical system, opposite the first magnet, where the second magnet may be rotatable, and a lever arm coupled to the second magnet, where the lever can be configured to rotate the second magnet.

Such embodiments, as well as others, may include one or more (i.e., one and/or combinations) the following features, structures, steps, functionality, and/or clarifications, each addition and combinations of additions yielding yet further embodiments of the disclosure:
the scanning device can be configured to move across a capture region of a ferrofluid system channel, where the scanning device may be configured to detect a number of a target species located in the capture region;
the second magnet can be rotatable by about 180 degrees;
the lever can be further configured to move both the first magnet and the second magnet from a first position to a second position along the sides of the optical system, such that:
   the first position can comprise opposite magnetic poles facing one another, and/or the opposite poles can be located a distance between about 12 mm to about 16 mm from a terminal end of the optical system;
   the second position can comprise like poles facing each other, and the like poles can be located within about 1 mm from a terminal end of the optical system;

and
the lever can be motorized and can be configured to move the first magnet and the second magnet from the second position to the first position;

In some embodiments, a ferrofluidic particle separation system for separating at least one target particle from a sample suspended in a ferrofluid is provided and includes a ferrofluid including a sample containing at least one target particle, a microfluidic channel having an inlet, and at least one outlet, where the inlet can be configured to receive the ferrofluid, a plurality of electrodes traversing at least a portion of the microfluidic channel length and generating a magnetic field pattern along the microfluidic channel length when a current is applied to at least one of the plurality of electrodes, and a scanning device for detecting the at least one target particle within a capture region of the microfluidic channel. The scanning device can comprise an optical system, a first magnet disposed on a first side of the optical system, where the first magnet can be non-rotatable, a second magnet disposed on a second side of the optical system, opposite the first magnet, where the second magnet can be rotatable, and a lever coupled to the second magnet, where the lever can be configured to rotate the magnet.

Such embodiments, as well as others, may include one or more (i.e., one and/or combinations) the following features, structures, steps, functionality, and/or clarifications, each addition and combinations of additions yielding yet further embodiments of the disclosure:
the sample comprises living cells;
the at least one target particle can be separated from the sample based on one or more characteristics of the at least one target particle;
the at least one target particle can be separated from the sample by directing the at least one target particle to a selected outlet or trapping the at least one target particle based on a spacing of at least two electrodes of the plurality of electrodes;
the at least one target particle can be separated from the sample based on a characteristic of the at least one target particle selected from the group consisting of target size, target shape, and target elasticity;
the lever can rotate a magnetic pole of the second magnet to face a like magnetic pole of the first magnet to generate a magnetic force in a downward direction;
the magnetic force pushes at least one non-targeted particle within the microfluidic channel to a lower surface of the microfluidic channel;
the scanning device measures the quantity of the at least one target particle disposed in a capture region of the channel;
the lever can be configured to move the first and the second magnets from a first position to a second position along the sides of the optical system;
the at least one target particle can be bound by a functionalized surface of the capture region; and
the lever can be motorized and can be configured to rotate the second magnet by about 180 degrees.

These and other embodiments, objects, and advantages of the present disclosure can also be found in the attached drawings (a brief description of which is provided below), and detailed description which follows.

### BRIEF DESCRIPTION OF THE DRAWINGS

FIG. 1a represents a side and perspective view of a portion of a system according to some embodiments.

FIGS. 1b-1c represents cross sectional views of portions of a scanning device according to some embodiments.

FIG. 2a depicts side view and cross-sectional view of a portion of a fluidic system according to some embodiments.

FIGS. 2b-2c depict top views of scan count displays according to some embodiments.

FIG. 3 is a flow chart of a method according to some embodiments.

FIG. 4 depicts a side and perspective view of a fluidic network/system according to some embodiments.

### DETAILED DESCRIPTION OF SOME OF THE EMBODIMENTS

Embodiments herein include a scanning apparatus for detecting target particles present within a ferrofluid, where the scanning apparatus can be used in a microfluidic system. The scanning apparatus includes opposing magnets disposed on an optical system that can be configured to generate a magnetic force which pushes non-targeted cells and other particles away from a detection surface. The methods and structures described herein include (for example), a scanning device comprising: an optical system, a first magnet disposed on a first side of the optical system, where the first magnet is (or can be, depending upon the embodiment) non-rotatable, a second magnet disposed on a second side of the optical system, opposite the first magnet, where the second magnet is (or can be, depending upon the embodiment) rotatable, and a lever arm coupled to the second magnet, where the lever can be configured rotate the second magnet.

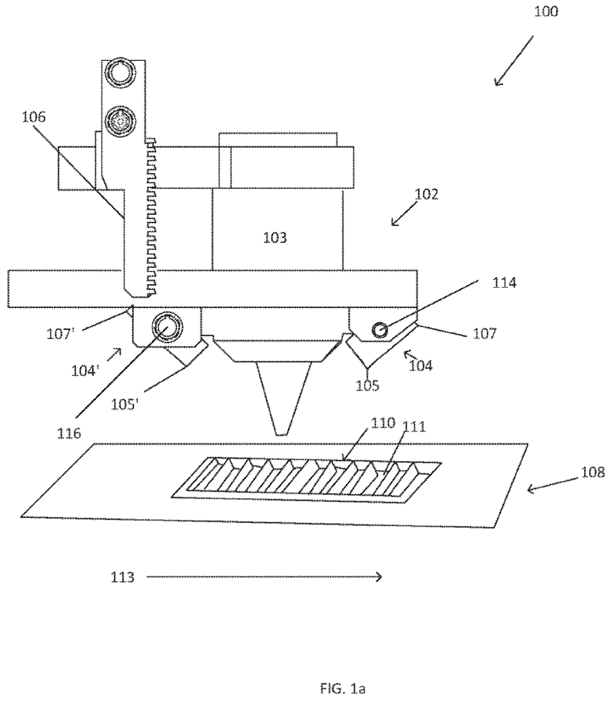

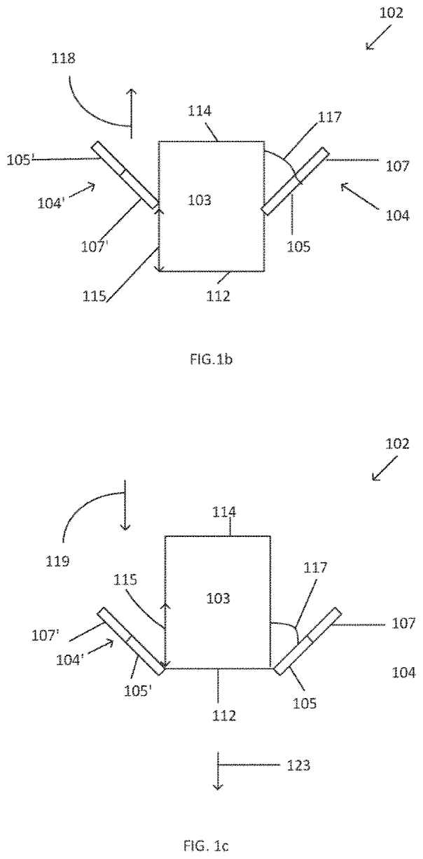

FIG. 1a depicts a portion of a system 100, including a detection portion of a ferrofluidic based assay system 100. A scanning device 102, such as an optical scanning device, may, in some embodiments, comprise a detecting device, such as an optical scanner, that may be provided and configured to detect target particles/moieties to be assayed by the system 100, to be described further herein. The scanning device 102 may comprise an optical system 103, in an embodiment, that may be operatively coupled to a processor (not shown) that may be configured to receive information associated with a portion of target particles detected by the scanning device 102. The optical system 103 may comprise a lens, such as an objective lens, for example, in some embodiments. In an embodiment, the scanning device 102 coupled with the processor may be configured to determine a characteristic associated with the portion of the plurality of target particles, such as quantitative and/or qualitative data, for example.

A first magnet 104, and a second magnet 104′, may be located on opposite sides of the optical system 103. The first magnet 104 may comprise a non-rotatable magnet, where the non-rotatable magnet comprises a first magnetic pole 105 and a second magnetic pole 107. The first and second magnetic poles 105, 107 may comprise opposite poles, such as a north pole and a south pole, respectively. The first magnet 104 may not be capable of (or configured to, both phrases being used interchangeably throughout the present disclosure) rotating the poles about an axis 114, for example, such that the poles 105, 107 are fixed in their respective configuration/location. The second magnet 104′ may comprise a rotatable magnet, in an embodiment, where the first and second poles 105′, 107′ of the rotatable magnet 104′ are capable of rotating about an axis, such as the axis 116, for example. In an embodiment, each of the first and second magnets 104, 104′ may comprise approximately equal magnetic strength. The location of the poles 105′, 107′ of the rotatable magnet 104′ may be flipped/rotated 180 degrees, such that like poles of the opposing first and second magnets 104, 104′ may either be facing or opposite each other. A lever 106, which may be motorized, may be coupled with the rotatable magnet 104′, and may function to move/rotate the moveable/rotatable magnet into a desired position with respect to the poles 105′, 107′.

A portion of a cartridge 108 may comprise at least one channel region 110 comprising at least one receptor region 111. The channel region 110 may contain a ferrofluid comprising a target moiety. The channel 110 of the cartridge 108 may hold a ferrofluid which flows across the channel 110 in a direction 113, that contains a target moiety/particle, where the target moiety may be captured/chemically affixed to the receptor region 111 of the channel. The receptor region 111 may comprise an antibody carpet/functionalized surfaces that may bind a target moiety thereto. Non-bound cells and/or species may not be bound to the antibody carpet/functionalized surface. The scanning device 102 may scan in the direction 113 across the cartridge 108, and may detect various qualitative and quantitative characteristics of the target moiety, such as a count of the numbers of a particular target moiety that reside/are attached within the receptor region 111. The scanning device 102 is capable of/configured to scan across the channel region 110 of the cartridge 108 while simultaneously pushing non-bound cells and/or species away from the receptor region 111 by generating a magnetic force from the first and second magnets, as will be further described herein.

FIG. 1b depicts a side/cross-sectional view of the scanning device 102, where the first magnet 104 and the second magnet 104′ are disposed in a first position, which may comprise an inactive position. In the inactive position, the second, rotatable magnet 104′ may be flipped, such as by 180 degrees, for example, by a lever arm, or any other suitable means/structure, in an embodiment, where both magnets 104, 104′ may be pulled up a distance 115 by a force 118 (such as may be applied by the lever 106 of FIG. 1a, for example). The force 118 may pull both the first and second magnets 104, 104′ away from the lower surface/edge 112 of the optical system 103 and may further rotate the rotatable magnet 104′ such that opposite poles of the magnets 104, 104′ may be facing each other across the optical system 103. For example, the pole 107′ of the second magnet 104′ may be facing the pole 105 of the first magnet, where the pole 107′ may comprise a north pole and the pole 105 may comprise a south pole, and vice versa. The force 118 may pull the first and second magnets 104, 104′ a distance 115 away from the lower surface 112 of the optical system, and may move both the magnets 104, 104′ towards the upper surface 114 the optical system 103. In an embodiment, the distance 115 may comprise between about 12 mm to about 16 mm, but may vary depending upon the particular optical system 103 size and application.

In the inactive mode depicted in FIG. 1b, the target particles/moiety cells that are bound to the antibody carpet of the receptor region (such as the receptor region of FIG. 1a, for example), and other non-targeted/non-bound particles within a channel being scanned, do not experience any appreciable magnetic force from the scanning device 102. In an embodiment, the first and second magnets 104, 104′ may be configured to be positioned at an angle 117 with respect to the optical system 103, where the angle 117 may comprise about 60 degrees in an embodiment. The scanning device 102 may not generate any significant magnetic force towards the channel 110 in the inactive mode.

FIG. 1c depicts a second position, that may comprise an active position, where like poles of the magnets 104, 104′ are facing in the same direction, towards each other across the optical system 103, and where both magnets 104, 104′ are pushed/moved downward a distance 115 by a force 119 (such as the force generated by the lever 106 of FIG. 1a) towards the lower surface 112 of the optical system 103, and are thereby moved closer to a channel being scanned, such as the channel 110 of FIG. 1a. The force 119 may also rotate the rotatable magnet 104′, such that the like poles 105, 105′ (such as N-N or S-S poles) of the first and second magnets 104, 104′ are facing each other. The like poles 105, 105′ of the magnets 104, 104′ generate a magnetic force 123 that may be directed towards receptor regions of a channel being scanned. The magnetic force 123 may comprise about 140 to about 180 Gauss in an embodiment. Target moieties/cells that are bound by the antibody carpet in the receptor regions are not pushed down by the magnetic force 123. However, non-bound cells and other particles are pushed down and away from the receptor region window surface by the magnetic force 123. Imaged (by a computer display for example) by the scanning device 102 through the ferrofluid carrier, such non-bound particles become invisible, and thus do not contribute to the cell count of the target moieties.

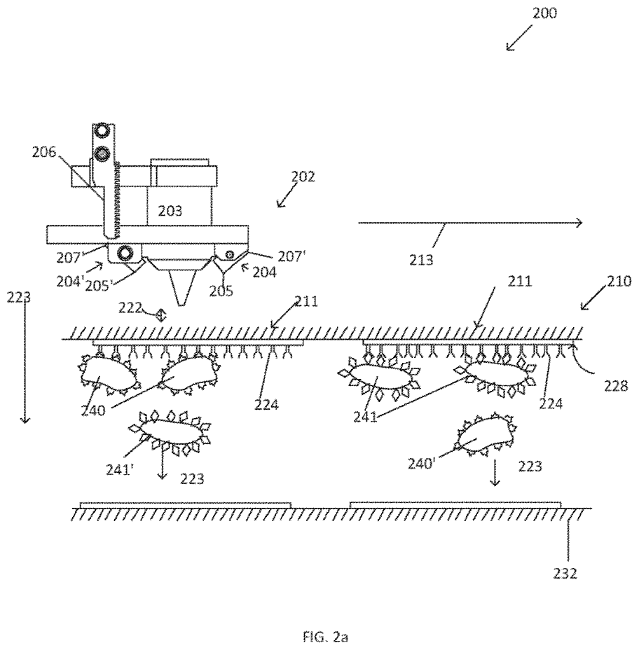

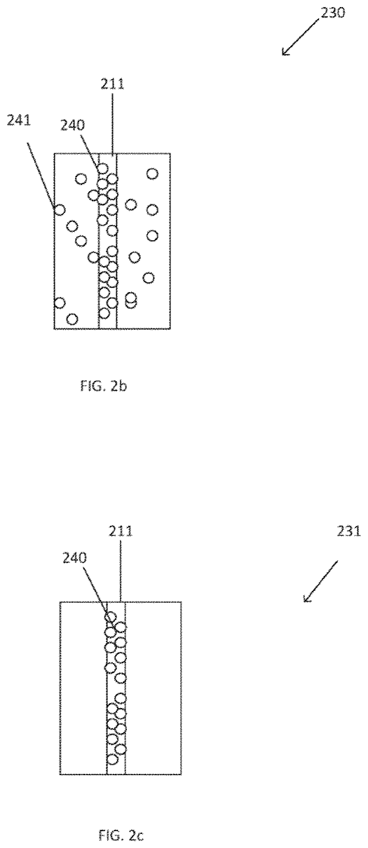

FIG. 2a depicts a cross-sectional view of a portion of a ferrofluidic system 200, where the scanning device 202 is capable of/configured to scan in a direction 213 across the receptor locations 211 of the channel 210. The scanning device 202 may be located a height 222 above the receptor locations 211, which may be varied according to a particular application. The scanning device 202 may scan the receptor locations 211 in the direction 213 from above the channel 210, and may detect, and may count, the number of target cells/moieties 240, 241 bound by the receptor sites 224 of the receptor/capture locations 211, in an embodiment. The receptor locations 211 may comprise antibody coated regions 211 and/or functionalized regions, disposed on an upper surface 228 of the flow channel 210. In an embodiment, the receptor locations 211 may comprise functionalized surfaces 224 that are functionalized to capture specific target cells 240, 241. Non-target cells/particles 241′, 240′ are not captured/bonded by the functionalized surfaces 224.

When the scanning device 202 is in an active position, such as in the active position of FIG. 1c for example, the magnets 204, 204′ of the scanning device 202 comprise like poles 205, 205′ facing in the same direction, such as north to north or south to south. The magnetic force 223 produced by the like poles 205, 205′ of the magnets 204, 204′, which may comprise between about 140 Gauss to about 180 Gauss, for example, may push the non-captured cells 240′, 241′ away from the receptor areas 211, since they are unbound, towards the bottom surface 232 of the channel. In this manner, by moving the moveable magnet 204′ such that like poles face each other over the receptor locations 211, the magnetic force 223 produced allows the scanner 202 to detect and/or count substantially only the target moieties, and does not detect and/or count the non-targeted, non-bound moieties/cells as it scans across the receptor regions 211. In an embodiment, the lever 206 may rotate the pole of the rotatable magnet 214′, and may push both the magnets 204, 204′ down a distance of the optical system 203 sidewall towards the bottom surface of the optical system, while the scanning is taking place over the receptor regions 211.

FIG. 2b depicts a top view of a first scan display 230 of a scan count obtained by the scanning device 202 while in the inactive mode. The first scan display 230 of the scan count depicts an image taken by the scanning device 202 where the magnets of the scanning device 202 have unlike poles facing each other as they capture the images of the target and non-target particles/cells. The first scan display 230 of the scan count, which may be viewed on a screen, such as a computer screen or any other suitable display screen, for example, depicts a scan count of target particles 240 captured by the capture/receptor regions 211 of the channel, such as the channel 210 of FIG. 2a, for example. Non-target particles 241 are also present in the first scan display 230, and are located a distance away from the capture region 211, since they are not bound by the capture regions 211. The scan count viewed in the first scan count display 230 may comprise an error in scan count, since it may be difficult to accurately measure/count/distinguish the target particles/cells 240 from the non-target cells/particles 241 in the scan display 230.

The second scan count display 231 FIG. 2c depicts a scan count display 231 where the same poles of the magnets of the scanning device 202 are facing each other, such as depicted in FIG. 1c, for example. The scan count viewed/depicted in the second scan count display 231 may comprise much less error in the scan count, since the non-bound non-target particles are pushed down towards the lower surface 232 of the channel 210, and thus are not viewable in the second scan count display 231. Thus, the second scan count display 231, where the scanning device 202 can be operated in the active mode, results in a much more accurate count of target particles 240, which is advantageous for bioassay applications, for example.

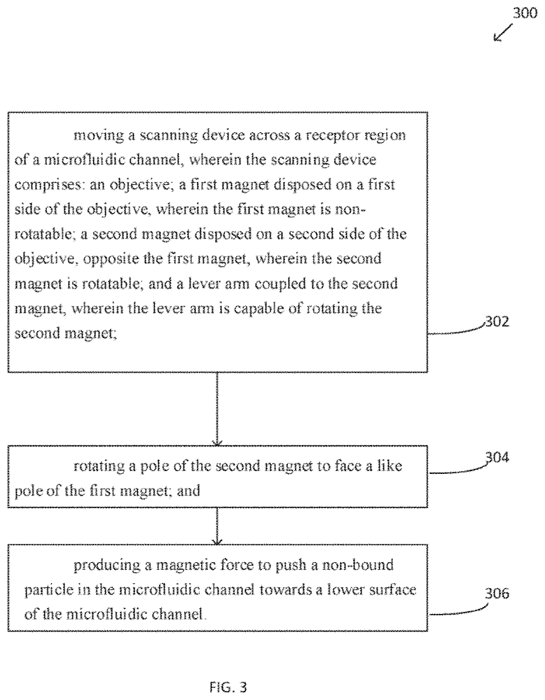

FIG. 3 depicts a flow chart of a method 300 of detecting target particles/moieties, according to embodiments. A ferrofluid may be utilized for bioassay in such applications as a medium for both microparticles and live cells, for example. In an embodiment, a commercially manufactured/prepared ferrofluidic material, such as Ferrotec EMG700, for example, may be provided. At step 302, a scanning device may be moved across a receptor region of a microfluidic channel, where the scanning device comprises: an optical system. A first magnet disposed on a first side of the optical system, where the first magnet can be non-rotatable, and a second magnet disposed on a second side of the optical system, opposite the first magnet, where the second magnet can be rotatable, and a lever arm coupled to the second magnet, where the lever arm is capable of/configured to rotate the second magnet. The scanning device may include a display coupled thereto, as well as a processor to analyze data retrieved by the scanning device.

At step 304, a pole of the second, rotatable magnet may be rotated to face a like pole of the first magnet. The lever arm may rotate the pole, and may further move both poles of the first and second magnets a distance down the optical system, closer to the receptor regions. In an embodiment, the first and second magnets may be moved down the optical system, and the rotatable pole may be rotated, while the scanning device can be moved over the receptor region. At step 306, a magnetic force may be produced to push a non-bound particle in the microfluidic channel towards a lower surface of the microfluidic channel. The receptor region may comprise both bound and non-bound particles, where the bound particles are bound to functionalized surfaces of the receptor region. The like poles of the two magnets facing each other generate a magnetic force that pushes the non-bound, non-targeted particles/moieties away from the scanning window of the receptor regions of the channel. Thus, the detected images of the scanning device possess greater accuracy, since the scans do not contain the non-targeted particles in the image.

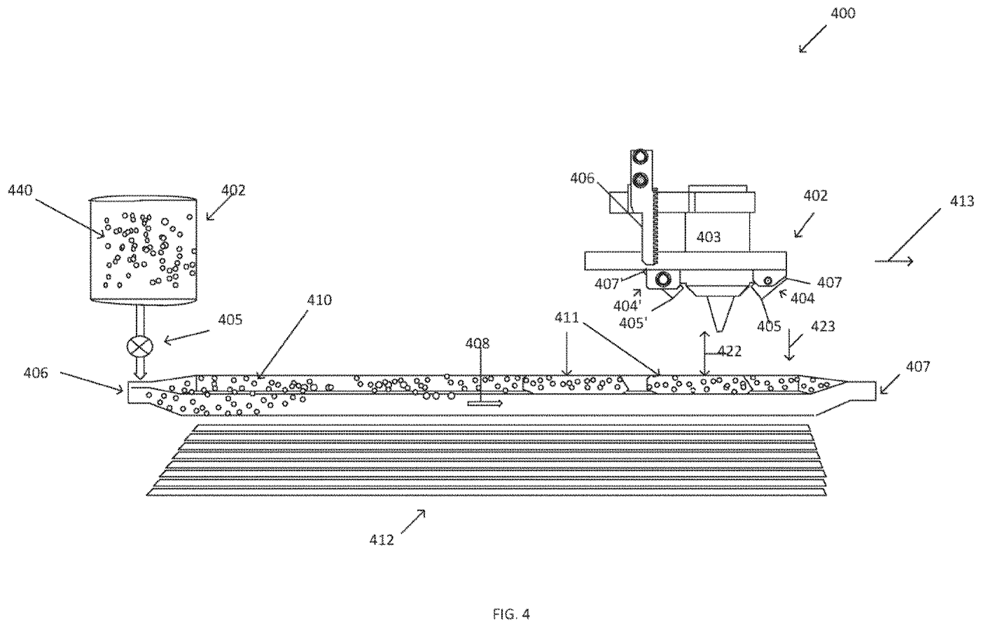

FIG. 4 depicts a continuous flow device/system 400, which may comprise a microfluidic system, in some embodiments, that is capable of/configured to being used to assay various biological samples. The system 400 is capable of/configured to separate at least one target from the sample that may be suspended in a ferrofluid, for example. Ferrofluids described herein may comprise colloidal mixtures of nanometer sized magnetic particles covered by a surfactant, suspended in a carrier medium that is compatible with the surfactant material. In one embodiment, particle diameters can range from about 1 nm to about 100 nm, and any whole or partial increments therebetween. For example, and without limitation, the particle diameters can range between 1-10 nm, 1-20 nm, 5-50 nm, or 10-100 nm. In a preferred embodiment, particle diameters average about 10 nm. Volume fractions may range from 0.1% to about 10%, and any whole or partial increments therebetween.

In another embodiment, the ferrofluids may be biocompatible, where live cells exhibit no deleterious effects for several hours in terms of physical properties, allowing for extended examination of the target sample. The biocompatible ferrofluid can be suitable for use with any living cell type and/or shape, such as any animal or plant tissue cell type, any microorganism, or any combination thereof, for example. Of course, the ferrofluid is also suitable for suspending any type of particle, and for any sized or shaped particle, or particle clusters or clumps, whether living or non-living.

In an embodiment, a sample 440, such as a target particle/moiety to be assayed may be suspended within a concentrated ferrofluid within a reservoir 402. The sample 440 (including ferrofluid, cells and or beads, such as microbeads. For example) may enter a device/channel inlet 406, and may be assisted by means of a pump and or pressure source 405. The sample 440 may pass/flow 408 in a direction through a channel/series of channels 410, and may exit via a channel outlet 407. The exiting sample may be directed towards waste or back to the reservoir 402.

A series of planar electrodes, electromagnets, and or a permanent magnetic array 412 may enable target moieties (such as salmonella cells, etc.) within the sample 440, to be captured at receptor regions 411. For example, the continuous flow device/system may be designed for capturing particles at receptor regions 411 of a particular size. A scanner/sensor device 402 (such as the scanning device of FIG. 2a, for example) may be employed to sense/quantify the amount of captured targeted moieties within a capture/receptor region(s) 411 of the channel 410. In an embodiment, the plurality of electrodes 412 may traverse at least a portion of the microfluidic channel 410 length and may generate a magnetic field pattern along the microfluidic channel length when a current is applied to at least one of the plurality of electrodes 412. In another embodiment, a magnetic field pattern may be configured to separate at least one target moiety as the target particles flow along at least a portion of the microfluidic channel length 410. The system 400 depicted in FIG. 4 is thus suitable for sorting two or more particle types based on one or a combination of size, shape and elasticity.

The number of the target cells 404 may be determined by a detecting apparatus 402, such as the scanning device 402. In some embodiments, the scanning device 402 may comprise an optical scanner 402, or any other suitable detector/scanner, and may be provided and configured to detect target particles captured and/or moving along the receptor regions 411. The scanner 402 may include, in some embodiments, impedance sensors, quartz crystal microbalance (QCM) sensors or surface plasmon resonance (SPR) sensors. The scanning device 402 may include a non-rotatable magnet 404 and a rotatable magnet 404′ located opposite each other on the optical system 403. A distance 422 between the scanning device 402 and the receptor regions 411 of the channel 410 may be varied depending upon the particular application.

A magnetic force 423 may be produced by first and second magnets 404, 404′ when in an active position. The active position can be achieved when a downward force is applied to the rotatable and non-rotatable magnets 404, 404′ by a mechanism/apparatus, such as a lever arm 406. The mechanism rotates the rotatable magnet 404′, as well as moves both the magnets 404, 404′, down a distance of the optical system, where the magnetic force produced pushes non-bound particles n the microfluidic channel towards a lower surface of the microfluidic channel, away from a scanning window of the receptor regions of the channel. Thus, the detected images of the scans produced by the scanning device of the embodiments herein possess greater accuracy, since the scans do not contain the non-targeted particles in the image.

While the principles of the disclosure have been illustrated in relation to the exemplary embodiments shown herein, the principles of the disclosure are not limited thereto and include any modification, variation or permutation thereof.

Example embodiments of the devices, systems and methods have been described herein. As noted elsewhere, these embodiments have been described for illustrative purposes only and are not limiting. Other embodiments are possible and are covered by the disclosure, which will be apparent from the teachings contained herein. Thus, the breadth and scope of the disclosure should not be limited by any of the above-described embodiments but should be defined only in accordance with claims supported by the present disclosure and their equivalents. Moreover, embodiments of the subject disclosure may include methods, systems and devices which may further include any and all elements from any other disclosed methods, systems, and devices, including any and all elements corresponding to ferrofluid concentration methods and systems utilizing the embodiments included herein. In other words, elements from one or another disclosed embodiment may be interchangeable with elements from other disclosed embodiments. In addition, one or more features/elements of disclosed embodiments may be removed and still result in patentable subject matter (and thus, resulting in yet more embodiments of the subject disclosure). Correspondingly, some embodiments of the present disclosure may be patentably distinct from one and/or another reference by specifically lacking one or more elements/features. In other words, claims to certain embodiments may contain negative limitation to specifically exclude one or more elements/features resulting in embodiments which are patentably distinct from the prior art which include such features/elements.

1. A magnetic force directing method for directing at least one non-bound particle in a microfluidic channel towards a surface of the microfluidic channel, method comprising:
moving a scanning device across a capture region of a microfluidic channel, wherein the scanning device comprises:
an optical system;
a first magnet disposed on a first side of the optical system, wherein the first magnet is non-rotatable;
a second magnet disposed on a second side of the optical system, opposite the first magnet, wherein the second magnet is rotatable; and
a lever arm coupled to the second magnet, wherein the lever arm is configured to rotate the second magnet;
rotating a pole of the second magnet to face a like pole of the first magnet; and
producing a magnetic force to push at least one non-bound particle in the microfluidic channel towards a first surface of the microfluidic channel.

2. The method of claim 1, wherein:
the method further comprises moving the first magnet and the second magnet away from the microfluidic channel along the sides of the optical system,
a plurality of target particles are bound to a functionalized surface of the capture region, and wherein a plurality of non-bound particles are disposed adjacent the bound target particles,
rotating a pole of the rotatable magnet comprises moving the lever a distance towards the surface of the channel.

3. The method of claim 2, wherein:
the first and second magnet are moved away from the microfluidic channel a predetermined distance, and/or
the magnetic force does not push the at least one non-bound particle towards the first surface of the microfluidic channel.

4. The method of claim 3, wherein the predetermined distance is between about 12 mm to about 16 mm away from the microfluidic channel.

5-6. (canceled)

7. The method of claim 2, wherein:
the scanning device detects the plurality of bound particles in the capture region, but does not detect the non-bound particles in the microfluidic channel, and/or
the plurality of target particles remain bound to the functionalized surface.

8. The method of claim 7, further comprising wherein the scanning device is configured to count the bound particles in the capture region.

9-10. (canceled)

11. A particle scanning system comprising:
an optical system;
a first magnet disposed on a first side of the optical system, wherein the first magnet is non-rotatable;
a second magnet disposed on a second side of the optical system, opposite the first magnet, wherein the second magnet is rotatable; and
a lever arm coupled to the second magnet, wherein the lever is configured to rotate the second magnet.

12. The scanning device of claim 11, wherein:
the scanning device is configured to move across a capture region of a ferrofluid system channel, wherein the scanning device is configured to detect a number of a target species located in the capture region,
the second magnet is rotatable by about 180 degrees, and/or
the lever is further configured to move both the first magnet and the second magnet from a first position to a second position along the sides of the optical system.

13-14. (canceled)

15. The scanning device of claim 12, wherein:
the first position comprises opposite magnetic poles facing one another, and the opposite poles are located a distance between about 12 mm to about 16 mm from a terminal end of the optical system,
the second position comprises like poles facing each other, and the like poles are located within about 1 mm from a terminal end of the optical system,
and/or
the lever is motorized and configured to move the first magnet and the second magnet from the second position to the first position.

16-17. (canceled)

18. A ferrofluidic particle separation system for separating at least one target particle from a sample suspended in a ferrofluid, the system comprising:
a ferrofluid including a sample containing at least one target particle;
a microfluidic channel having an inlet, and at least one outlet, wherein the inlet is to receive the ferrofluid;
a plurality of electrodes traversing at least a portion of the microfluidic channel length and generating a magnetic field pattern along the microfluidic channel length when a current is applied to at least one of the plurality of electrodes;
a scanning device for detecting the at least one target particle within a capture region of the microfluidic channel, the scanning device comprising:
an optical system;
a first magnet disposed on a first side of the optical system, wherein the first magnet is non-rotatable;
a second magnet disposed on a second side of the optical system, opposite the first magnet, wherein the second magnet is rotatable; and
a lever coupled to the second magnet, wherein the lever is configured to rotate the magnet.

19. The system of claim 18, wherein the sample comprises living cells.

20. The system of claim 18, wherein the at least one target particle is separated from the sample based on one or more characteristics of the at least one target particle.

21. The system of claim 18, wherein the at least one target particle is separated from the sample by directing the at least one target particle to a selected outlet or trapping the at least one target particle based on a spacing of at least two electrodes of the plurality of electrodes.

22. The system of claim 18, wherein the at least one target particle is separated from the sample based on a characteristic of the at least one target particle selected from the group consisting of target size, target shape, and target elasticity.

23. The system of claim 18, wherein the lever rotates a magnetic pole of the second magnet to face a like magnetic pole of the first magnet to generate a magnetic force in a downward direction.

24. The system of claim 23, wherein the magnetic force pushes at least one non-targeted particle within the microfluidic channel to a lower surface of the microfluidic channel.

25. The system of claim 18, wherein the scanning device measures the quantity of the at least one target particle disposed in a capture region of the channel.

26. The system of claim 18, wherein the lever is configured to move the first and the second magnets from a first position to a second position along the sides of the optical system.

27. The system of claim 25, wherein the at least one target particle is bound by a functionalized surface of the capture region.

28. The system of claim 18, wherein the lever is motorized and is configured to rotate the second magnet by about 180 degrees.
